(19) United States
(12) Patent Application Publication
(10) Pub. No.: US 2012/0288709 A1
(43) Pub. Date: Nov. 15, 2012

(54) Multilayered Film Having Excellent Barrier and Thermal Adhesion Properties

(75) Inventors: MinHo Jeon, Daejeon (KR); MoonJung Choi, Seoul (KR); MyungAhn Ok, Daejeon (KR)

(73) Assignees: SK GLOBAL CHEMICAL CO., LTD., Seoul (KR); SK INNOVATION CO., LTD., Seoul (KR)

(21) Appl. No.: 13/466,198

(22) Filed: May 8, 2012

(30) Foreign Application Priority Data
May 9, 2011 (KR) 10-2011-0043331

(51) Int. Cl. B32B 27/08; B29C 47/06

(52) U.S. Cl. 428/349; 264/173.16

(57) ABSTRACT

Provided is a molded body where aliphatic polycarbonate and polypropylene are laminated in two or more layers, and more particularly, if aliphatic polycarbonate and polypropylene according to the present invention are co-extruded and bi-axially oriented, since two layers are easily attached by only a simple process while an additional process for introducing a barrier layer and an adhesion agent or a adhesion layer (tie layer) are not provided, stripping does not occur, excellent oxygen barrier property may be provided as compared to only bi-axially oriented polypropylene, in the case where aliphatic polycarbonate is present on a surface layer, a heat sealing property and a thermal adhesion property to paper may be provided at low temperatures, and an additional adhesion agent or adhesion layer (tie layer) are not required, cost is reduced and a layer constitution is simplified to significantly reduce manufacturing costs.

### CROSS-REFERENCE TO RELATED APPLICATIONS

This application claims priority under 35 U.S.C. §119 to Korean Patent Application No. 10-2011-0043331, filed on May 9, 2011, in the Korean Intellectual Property Office, the disclosure of which is incorporated herein by reference in its entirety.

### TECHNICAL FIELD

The following disclosure relates to a bi-axially oriented polypropylene film having barrier and thermal adhesion properties manufactured by co-extruding aliphatic polycarbonate and polypropylene, and then performing biaxial orienting, and a method for manufacturing the same.

### BACKGROUND

A bi-axially oriented polypropylene film (BOPP film) means a polypropylene film that is oriented in a longitudinal direction (MD) that is a flow direction of the film, in other words, a machine direction, and a transverse direction (TD) while manufacturing the film. The BOPP film is used for the purpose of various flexible packaging films or labels with high strength and excellent tensile property, transparency, and water vapor barrier property.

However, since the BOPP film has high oxygen permeability because of high oxygen permeability of polypropylene (PP), an application thereof is limited in a packaging field requiring prevention of rancid acidification. Currently, in order to manufacture the BOPP film having the oxygen barrier property, the BOPP film having the barrier property is manufactured by laminating or applying polyvinylidene chloride (PVDC) or nylon having the high oxygen barrier property. However, in the case of polyvinylidene chloride, there is a disadvantage in term of environmental portion because a halogen element is environmentally controlled, and the process has a disadvantage in that a coating process is added to require an additional cost of the process. In addition, nylon has a disadvantage in that an additional process cost is required because of lamination. Separately, there is a case where oxygen permeability is reduced by depositing an aluminum layer, but the case has a disadvantage in term of economic efficiency because the deposition process of aluminum is introduced as an additional process.

In addition, in the case where the BOPP film is used while being bonded to paper, a method for attaching the film to paper after an adhesion agent is applied on the BOPP film or a method for attaching the film to paper by heat after an ethylene-vinyl acetate (EVA) copolymer resin is extrusion-applied on the BOPP film is used to attach the film to paper, but the method has a disadvantage in term of economic efficiency because an additional process is introduced.

### SUMMARY

An embodiment of the present invention is directed to providing a bi-axially oriented polypropylene film having barrier and thermal adhesion properties, which can be manufactured by a simple process because an additional process for introducing an oxygen barrier property is not required by performing biaxial orienting after aliphatic polycarbonate and polypropylene are co-extruded and does not require an additional adhesion agent or adhesion layer (tie layer) because an adhesion property at an interface between two resins is excellent.

Specifically, the embodiment of the present invention is directed to providing a molded body that can provide excellent oxygen barrier property as compared to a molded body using polypropylene and provide a heat sealing property and a thermal adhesion property to paper at low temperatures in the case where aliphatic polycarbonate is present on a surface layer, and can be manufactured by a simple process while an additional process for introducing a layer increasing oxygen barrier and thermal adhesion properties is not required, such that manufacturing costs can be significantly reduced, and since an additional adhesion agent or adhesion layer (tie layer) increasing adhesion strength between layers in the multilayered film is not required, cost of a raw material is reduced and a layer constitution is simplified to significantly reduce manufacturing costs.

The present invention relates to a multilayered film having excellent barrier and thermal adhesion properties, including an aliphatic polycarbonate layer and a polypropylene polymer layer laminated to each other, and a multilayered film where the aliphatic polycarbonate layer and the polypropylene polymer layer are alternately laminated and two or more layers are laminated.

The present inventors found that in the case where aliphatic polycarbonate and polypropylene are co-extruded, stripping easily occurs because there is no adhesion strength between two resins, but in the case where aliphatic polycarbonate and polypropylene are bi-axially oriented, two layers are easily attached and stripping does not occur without an adhesion agent or an adhesion layer (tie layer), thereby accomplishing the present invention.

Accordingly, it was found that if aliphatic polycarbonate and polypropylene are used after aliphatic polycarbonate and polypropylene are laminated to have a multilayered structure of two or more layers and bi-axially oriented, excellent oxygen barrier property may be provided as compared to a bi-axially oriented polypropylene (BOPP) film formed of only polypropylene, a simple manufacturing process formed of only co-extrusion and bi-axially orienting is ensured as compared to a bi-axially oriented polypropylene (BOPP) having barrier property, to which polyvinylidene chloride (PVDC), Nylon, and aluminum are introduced, and since an additional adhesion agent and tie layer are not required, cost is reduced and a layer constitution is simplified to significantly reduce manufacturing costs.

In addition, in the case of the bi-axially oriented molded body having the lamination structure of aliphatic polycarbonate and polypropylene thusly molded, that is, in the case of the multilayered film, while excellent film properties such as tensile and tearing properties and optical properties of polypropylene are maintained, excellent oxygen barrier property of aliphatic polycarbonate is exhibited, such that the multilayered film may be used as a water vapor and oxygen barrier film.

In addition, an additional adhesion layer should be introduced to a general bi-axially oriented polypropylene film during a process of bonding the film to a substrate such as paper, but the multilayered film where aliphatic polycarbonate is introduced to the surface layer has advantages in that the film can be sealed by heat at low temperatures and can be laminated on paper by only a simple process and layer constitution because of an adhesion property of aliphatic polycarbonate to paper.

One general aspect of the present invention is, as shown in FIG. 1, a film or sheet having a two-layered structure including an aliphatic polycarbonate layer 10 and a polypropylene layer 20 laminated on one surface of the aliphatic polycarbonate layer 10.

Another general aspect of the present invention is, as shown in FIG. 2, a film or sheet having a three-layered structure including an aliphatic polycarbonate layer 10 and polypropylene layers 20 laminated on both surfaces of the aliphatic polycarbonate layer 10.

Another general aspect of the present invention is, as shown in FIG. 3, a film or sheet having a three-layered structure including a polypropylene layer 20 and aliphatic polycarbonate layers 10 laminated on both surfaces of the polypropylene layer 20.

Another general aspect of the present invention is, as shown in FIG. 4, a film or sheet having a four-layered structure where aliphatic polycarbonate layer 10/polypropylene layer 20/aliphatic polycarbonate layer 10/polypropylene layer 20 are laminated.

Another general aspect of the present invention is, as shown in FIG. 5, a film or sheet having a five-layered structure where aliphatic polycarbonate layer 10/polypropylene layer 20/aliphatic polycarbonate layer 10/polypropylene layer 20/aliphatic polycarbonate layer 10 are laminated.

Another general aspect of the present invention is, as shown in FIG. 6, a film or sheet having a five-layered structure where polypropylene layer 20/aliphatic polycarbonate layer 10/polypropylene layer 20/aliphatic polycarbonate layer 10/polypropylene layer 20 are laminated.

However, these aspects are set forth to clearly illustrate constitution of the present invention, but not limited thereto as long as the aspects have a structure of two or more layers.

In addition, an appropriate additive such as a slip agent and a blocking prevention agent may be further introduced to an outer layer of each multilayered film in order to provide a slipping property and to prevent blocking, and a kind thereof is not limited.

In the present invention, lamination means a matter formed by co-extrusion and bi-axial orienting, and lamination may be performed by a simple process formed of only the co-extrusion and the bi-axial orienting to provide a polypropylene multilayered film having a barrier property and excellent adhesion property without an adhesion agent or a adhesion layer (tie layer) because of excellent adhesion property between aliphatic polycarbonate and polypropylene polymer.

Hereinafter, constitution of the present invention will be described in more detail.

In the present invention, a polycarbonate copolymer or terpolymer obtained by reacting carbon dioxide, and one or more kinds of epoxide compounds selected from the group consisting of (C2-C10)alkylene oxide substituted or unsubstituted by halogen or (C1-C10)alkoxy; (C4-C20)cycloalkylene oxide substituted or unsubstituted by halogen or (C1-C10)alkoxy; and (C8-C20)styrene oxide substituted or unsubstituted by halogen, (C1-C10)alkoxy, (C1-C10)alkyl, or (C6-C20)aryl may be used as the aliphatic polycarbonate.

Specific examples of alkoxy may include alkyloxy, aryloxy, aralkyloxy, and the like, and examples of aryloxy may include phenoxy, biphenyloxy, naphthyloxy, and the like. Alkoxy, alkyl, and aryl may be a matter having a substituent group selected from a halogen element or an alkoxy group.

In the present invention, specific examples of the epoxide compound include ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxidenorbornene, limonene oxide, dieldrine, 2,3-epoxidepropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxidepropyl ether, epoxypropyl methoxyphenyl ether biphenyl glycidyl ether, glycidyl naphthyl ether, and the like.

Solution polymerization or bulk polymerization is feasible as a method for polymerizing the polycarbonate copolymer or terpolymer, and more specifically, an organic solvent is used as a reaction medium, and one or more kinds of epoxide compounds and carbon dioxide are added under the presence of catalyst to perform polymerization. Any one or combination of two or more of aliphatic hydrocarbons such as pentane, octane, decane and cyclohexane, aromatic hydrocarbons such as benzene, toluene, and xylene, and halogenated hydrocarbons such as chloromethane, methylene chloride, chloroform, carbon tetrachloride, 1,1-dichloroethane, 1,2-dichloroethane, ethyl chloride, trichloroethane, 1-chloropropane, 2-chloropropane, 1-chlorobutane, 2-chlorobutane, 1-chloro-2-methylpropane, chlorobenzene, and bromobenzene may be used as the solvent. Pressure of carbon dioxide may be normal pressure to 100 atm, and preferably 5 to 30 atm. During the copolymerization reaction, a polymerization temperature may be 20 to 120° C., and preferably 50 to 90° C. More preferably, bulk polymerization using a monomer as the solvent may be performed.

More specifically, polyalkylene carbonate may be used as aliphatic polycarbonate, and it is more preferable to use polypropylene carbonate in order to manufacture the multilayered film exhibiting high oxygen barrier property.

It is preferable that the weight average molecular weight of aliphatic polycarbonate be 50,000 to 500,000. In addition, a melt index MI (ASTM D-1238, 150° C., 5 kg) is 0.1 to 200 g/10 min and preferably 1 to 50 g/10 min, and a molecular weight distribution (Mw/Mn) is 1.3 or more and preferably 2.5 or more.

In the present invention, a homopolymer of propylene or a copolymer including a propylene unit may be used as polypropylene, and the copolymer may be any one of propylene random copolymers including the propylene unit and a small amount (for example, 10 mol % or less and preferably 5 mol % or less) of olefin unit other than propylene. In this case, a-olefin having 2 to 20 carbon atoms, for example, 1-butene, 1-pentene, 1-hexene, 1-heptene, 1-octene, 1-decene, 1-dodecene, 1-hexadecene, 4-methyl-1-pentene, and the like may be used as the comonomer used while manufacturing the copolymer.

It is preferable that the weight average molecular weight of polypropylene be 50,000 to 300,000. The melt index MI (ASTM D-1238, 230° C., 2.16 kg) of polypropylene is 0.1 to 400 g/10 min and preferably 1 to 100 g/10 min, and the molecular weight distribution (Mw/Mn) is 3 or more and preferably 4 to 15.

The present invention manufactures the aliphatic polycarbonate resin and the polypropylene resin in a resin composition and performs co-extrusion. In this case, the resin composition may be manufactured in a master batch pellet form.

If necessary, an additive, typically used to manufacture a film or sheet, such as a pigment, a dye, a filler, an antioxidant, a UV-blocking agent, an antistatic agent, a blocking prevention agent, and a slip agent, may be further added to the resin composition, and a kind thereof is not limited.

Next, a method for manufacturing a bi-axially oriented polypropylene film having a barrier property of the present invention will be described in more detail.

A method for manufacturing a multilayered film of the present invention includes a) manufacturing a first resin composition including aliphatic polycarbonate; b) manufacturing a second resin composition including polypropylene; c) performing co-extrusion by using a blown or casting type molding machine after the first resin composition and the second resin composition are melted; and d) bi-axially orienting a co-extruded molded body.

In the present invention, with respect to a preferable melt temperature range during the co-extrusion, aliphatic polycarbonate is melt-extruded at the temperature in the range of 120 to 220° C., the polypropylene resin is melt-extruded at 140 to 300° C., and the co-extrusion is performed by using a blown or casting type film molding machine. When the melt temperature is lower than the aforementioned temperature range, a process speed is reduced, and adhesion strength between layers is reduced, and when the melt temperature is higher than the aforementioned temperature range, thermal decomposition excessively occurs, such that bubbles may be formed in the sheet due to byproducts of thermal decomposition.

In addition, two or more layers may be laminated by controlling a form of die during co-extrusion, and the number of layers is not limited.

To be more specific, for example, two layers of the first resin composition/second resin composition may be laminated, three layers of the second resin composition/first resin composition/second resin composition may be laminated, three layers of the first resin composition/second resin composition/first resin composition may be laminated, four layers of the first resin composition/second resin composition/first resin composition/second resin composition may be laminated, five layers of the first resin composition/second resin composition/first resin composition/second resin composition/first resin composition may be laminated, or five layers of the second resin composition/first resin composition/second resin composition/first resin composition/second resin composition may be laminated.

In the present invention, the bi-axially oriented polypropylene film having the barrier property may be manufactured by performing orienting at 60 to 190° C. in a longitudinal direction and a transverse direction 2 to 8 times. In this case, examples of orienting may include roll orienting or tenter orienting, and orienting may be performed by a known method such as simultaneous bi-axial orienting, two step bi-axial orienting, or a double bubble method.

It is preferable that the thickness of the bi-axially oriented final laminated film having a lamination structure of two or more layers be 5 to 100 μm, but the thickness is not limited thereto and may be controlled to be used according to the application field thereof.

### BRIEF DESCRIPTION OF THE DRAWINGS

FIG. 1 is a cross-sectional view illustrating a multilayered film having a two-layered structure according to the present invention.

FIG. 2 is a cross-sectional view illustrating an exemplary embodiment of a multilayered film having a three-layered structure according to the present invention.

FIG. 3 is a cross-sectional view illustrating another exemplary embodiment of the multilayered film having the three-layered structure according to the present invention.

FIG. 4 is a cross-sectional view illustrating an exemplary embodiment of a multilayered film having a four-layered structure according to the present invention.

FIG. 5 is a cross-sectional view illustrating an exemplary embodiment of a multilayered film having a five-layered structure according to the present invention.

FIG. 6 is a cross-sectional view illustrating another exemplary embodiment of the multilayered film having the five-layered structure according to the present invention.

FIG. 7 is a scanning electron microscope (SEM) picture obtained by measuring a cross-section of a bi-axially oriented polypropylene film having a barrier property according to Example 1 of the present invention.

FIG. 8 is a scanning electron microscope (SEM) picture obtained by measuring a cross-section of a bi-axially oriented polypropylene film according to Example 2 of the present invention.

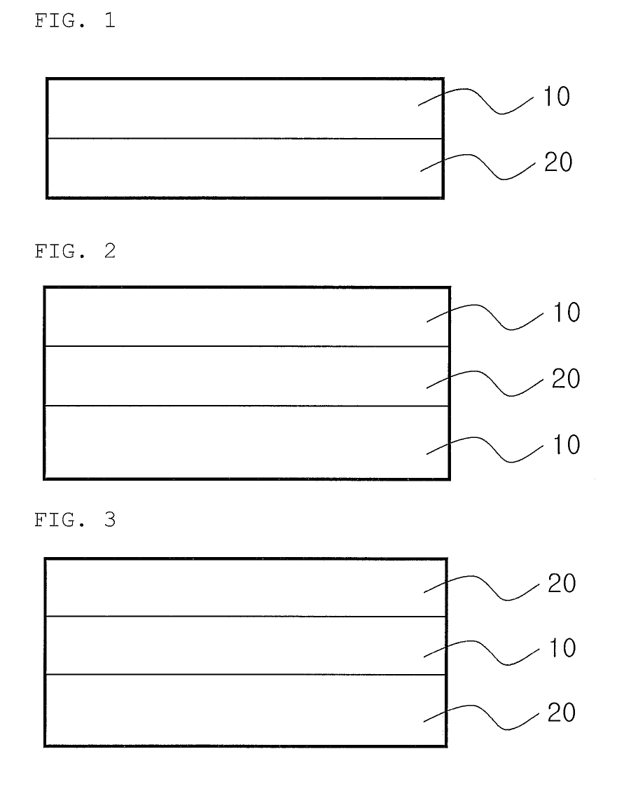

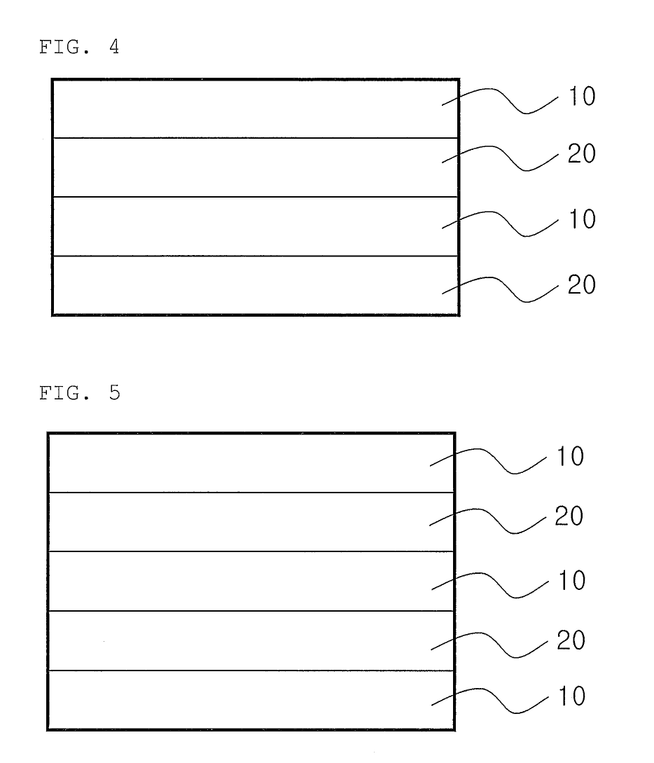

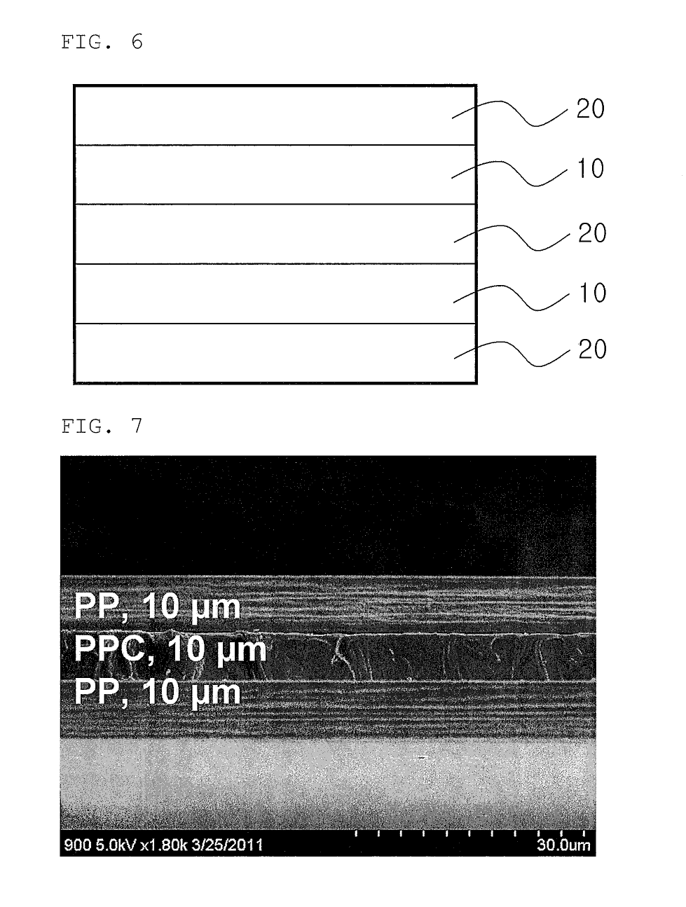

### DETAILED DESCRIPTION OF MAIN ELEMENTS

10: Aliphatic polycarbonate layer

20: Polypropylene layer

### DETAILED DESCRIPTION OF EMBODIMENTS

A better understanding of the present invention may be obtained in light of the following Examples which are set forth to illustrate, but are not to be construed to limit the present invention.

Hereinafter, physical properties were measured by the following method.

1) Weight Average Molecular Weight

The weight average molecular weight was measured by using the gel permeability chromatography method using solvent THF (tetrahydrofuran) (normal temperature GPC, Agilent 1200 HPLC).

2) Film Thickness

Thicknesses of several points of the bi-axially oriented polypropylene film having the barrier property were measured (TOYOSEIKI Thickness Meter Model: B-1), and the average value thereof was used.

3) Stripping

After the bi-axially oriented polypropylene film was cut to have the width of 5 cm and the length of 20 cm, the adhesion tape was attached to both surfaces of the film so that the entire width of the film is included and is 5 cm in a length direction, it was observed whether stripping occurred or not while both sides of the adhesion tape were pulled in a direction perpendicular to the surface of the film, and the case where stripping did not occur three times was evaluated as the case of no stripping.

4) Tensile Strength and Elongation

The tensile strength and elongation were measured by the ASTM D-638 method using the universal testing machine (INSTRON 4301).

5) Haze

The bi-axially oriented polypropylene film was cut to have the width of 7 cm and the length of 7 cm, turbidity was measured two times or more, and the average value thereof was used (Haze Meter 300A, NIPPON DENSHOKU).

6) Oxygen Permeability

The oxygen permeability was measured by using MOCON OX-TRAN equipment (Model 2161).

7) Water Vapor Permeability

The water vapor permeability was measured by using MOCON PERMATRAN-W equipment (Model 3133).

8) Heat Sealing Initiation Temperature

After heat sealing by using heat gradient tester equipment (Model No. D-342000700) by Toyoseiki at a pressure of 2 kg for 1 sec, the temperature at which the heat sealing strength was 500 g or more was measured when the heat sealing strength was measured by using the universal testing machine (INSTRON 4301).

### EXAMPLE 1

Polypropylene carbonate having the weight average molecular weight of 150,000 (PPC, SK Energy, Co., Ltd.) and polypropylene (PP, H230W, MI 3, SK Energy, Co., Ltd.) were each added to the extruder, melted, and co-extruded through the T-die to manufacture the three-layered film of PP/PPC/PP. In this case, during the co-extrusion, polypropylene carbonate was melt-extruded at the extruder temperature of 120/160/165/175/180° C., and polypropylene was melt-extruded at the extruder temperature of 160/170/180/180/190° C. The manufactured co-extrusion film was oriented by 5×5 times in the longitudinal direction and transverse direction in the biaxial orienting machine at 155° C. to manufacture the bi-axially oriented polypropylene film having the barrier property.

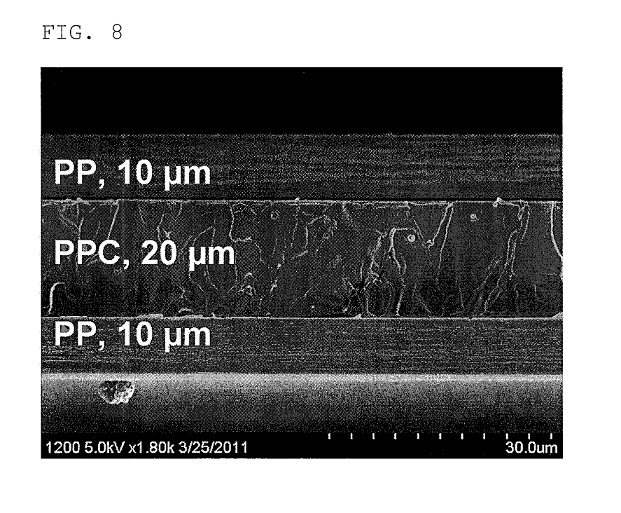

The thickness of the manufactured bi-axially oriented polypropylene film having the barrier property was measured, and as a result, the thickness thereof was 30 μm, and the thickness of each layer was 10 μm/10 μm/10 μm (FIG. 7). After physical properties of the manufactured film was measured, the results were described in the following Table 1.

### EXAMPLE 2

The film was manufactured while controlling the thickness ratio of the layer of PPC by using the same equipment and resin as Example 1, the thickness of each layer of PP/PPC/PP was 10 μm/20 μm/10 μm, and the total thickness was 40 μm (FIG. 8). After physical properties of the manufactured film were measured, the results were described in the following Table 1.

### EXAMPLE 3

The film was manufactured while changing constitution of the laminated layers by using the same equipment and resin as Example 1, constitution of each layer was a two-layered structure of PP/PPC, the thickness of each layer of PP/PPC was 20 μm/20 μm, and the total thickness was 40 μm. After physical properties of the manufactured film were measured, the results were described in the following Table 1.

### EXAMPLE 4

The film was manufactured while changing constitution of the laminated layers by using the same equipment and resin as Example 1, constitution of each layer was PPC/PP/PPC/PP/PPC, the thickness of each layer of PPC/PP/PPC/PP/PPC was 5 μm/10 μm/10 μm/10 μm/5 μm, and the total thickness was 40 μm.

After physical properties of the manufactured film was measured, the results were described in the following Table 1.

### COMPARATIVE EXAMPLE 1

The film according to the present invention and the bi-axially oriented polypropylene film formed of only polypropylene as the control group were used.

Polypropylene (PP, H230W, MI 3, SK Energy, Co., Ltd.) was added to the extruder, melted, and extruded through the T-die, and the extrusion temperature was 160/170/180/180/190° C. After extrusion, orienting was performed 5×5 times in the longitudinal direction and transverse direction by the biaxial orienting machine at the temperature of 155° C., and the final thickness of the manufactured film was 30 μm.

After physical properties of the manufactured film were measured, the results were described in the following Table 1.

TABLE 1

| | | Ex- | Ex- | Ex- | Ex- | |
|---|---|---|---|---|---|---|
| | | am- | am- | am- | am- | Comparative |
| | Unit | ple 1 | ple 2 | ple 3 | ple 4 | Example 1 |
| Stripping | — | No | No | No | No | — |
| | | strip- | strip- | strip- | strip- | |
| | | ping | ping | ping | ping | |
| Film thickness | μm | 30 | 40 | 40 | 40 | 30 |
| Yield point | Kg/cm² | 1400 | 1200 | 1350 | 1500 | 1300 |
| (MD) | | | | | | |
| Breakage point | Kg/cm² | 1400 | 1200 | 1300 | 1400 | 1400 |
| (MD) | | | | | | |
| Elongation at | % | 40 | 45 | 35 | 45 | 45 |
| breakage (MD) | | | | | | |
| Haze | — | 1 | 2 | 2 | 2 | 1 |
| Oxygen | cc/m² | 160 | 80 | 80 | 80 | 2400 |
| permeability | day | | | | | |
| (23° C., RH 0%) | | | | | | |
| Water vapor | cc/m² | 4 | 4 | 4 | 4 | 5 |
| permeability | day | | | | | |
| (38° C., RH 100%) | | | | | | |
| Heat sealing | ° C. | — | — | 60 | 60 | 175 |
| initiation | | | | | | |
| temperature | | | | | | |

As shown in Table 1, it can be seen that the films of Examples 1 and 2 according to the present invention have excellent oxygen permeability and water vapor permeability while basically maintaining excellent film properties such as tensile, elongation, and haze, which are physical properties of the bi-axially oriented polypropylene film.

In addition, it can be seen that the films of Examples 3 and 4 according to the present invention have excellent oxygen permeability and water vapor permeability and are sealed by heat at low temperatures while basically maintaining excellent film properties such as tensile, elongation, and transparency, which are physical properties of the bi-axially oriented polypropylene film.

A multilayered film according to the present invention can be manufactured by a simple process formed of only co-extrusion and bi-axial orienting without an additional process for introducing polyvinylidene chloride, nylon, aluminum, and the like having an oxygen barrier property, the manufactured bi-axially oriented film does not additionally require an adhesion agent or an adhesion layer (tie layer), and it is possible to provide the bi-axially oriented polypropylene film having the barrier property and physical properties improved due to excellent adhesion property between resins.

In addition, the multilayered film according to the present invention can be used as a barrier film because of excellent film property of the polypropylene polymer and excellent barrier property of aliphatic polycarbonate, and particularly, since oxygen and water vapor barrier properties are excellent, the multilayered film can be used as a packaging material having excellent barrier property in various fields such as films, sheets, and fibers. Besides the barrier property and film property, in the case where aliphatic polycarbonate is introduced to the surface layer, it is possible to provide the bi-axially oriented polypropylene film having the thermal adhesion property, which can be laminated with paper by a simple process without introduction of an additional adhesion layer because of excellent thermal adhesion property of polypropylene carbonate at low temperatures.

What is claimed is:

1. A multilayered film having excellent barrier and thermal adhesion properties, comprising:
an aliphatic polycarbonate layer and a polypropylene polymer layer laminated each other.

2. The multilayered film of claim 1, wherein the lamination is formed by co-extrusion and biaxial orienting, and two or more layers are laminated.

3. The multilayered film of claim 2, wherein after aliphatic polycarbonate is melted at 120 to 220° C. and polypropylene is melted at 140 to 300° C., the co-extrusion is performed by using a blown or casting type film molding machine.

4. The multilayered film of claim 2, wherein in the biaxial orienting, an orienting temperature is 60 to 190° C., and an orienting ratio of each of a longitudinal direction and a transverse direction is 2 to 8.

5. The multilayered film of claim 1, wherein the aliphatic polycarbonate is a polycarbonate copolymer or terpolymer obtained by reacting carbon dioxide, and one or more kinds of epoxide compounds selected from the group consisting of (C2-C10)alkylene oxide substituted or unsubstituted by halogen or (C1-C10)alkoxy; (C4-C20)cycloalkylene oxide substituted or unsubstituted by halogen or (C1-C10)alkoxy; and (C8-C20)styrene oxide substituted or unsubstituted by halogen, (C1-C10)alkoxy, (C1-C10)alkyl, or (C6-C20)aryl.

6. The multilayered film of claim 5, wherein the aliphatic polycarbonate has a weight average molecular weight of 50,000 to 500,000, and MI (ASTM D-1238, 150° C., 5 kg) of 0.1 to 200 g/10 min.

7. The multilayered film of claim 5, wherein the aliphatic polycarbonate is polypropylene carbonate.

8. The multilayered film of claim 1, wherein the polypropylene is a propylene homopolymer or a copolymer including a propylene unit.

9. A method for manufacturing a multilayered film having excellent barrier and thermal adhesion properties, comprising:
a) manufacturing a first resin composition including aliphatic polycarbonate;
b) manufacturing a second resin composition including polypropylene;
c) performing co-extrusion by using a blown or casting type molding machine after the first resin composition and the second resin composition are melted; and
d) bi-axially orienting a co-extruded molded body.

10. The method of claim 9, wherein in the co-extrusion of c), the first resin composition and the second resin composition are laminated in two or more layers.

11. The method of claim 9, wherein in the co-extrusion of c), the first resin composition is melt-extruded at 120 to 220° C., and the second resin composition is melt-extruded at 140 to 300° C.

12. The method of claim 9, wherein the orienting is biaxial orienting at 60 to 190° C. and an orienting ratio of each of a longitudinal direction and a transverse direction of 2 to 8.
